(19) United States
(12) Patent Application Publication
(10) Pub. No.: US 2006/0075237 A1
(43) Pub. Date: Apr. 6, 2006

(54) Fingerprinting multimedia contents

(75) Inventors: Jin Soo Seo, Daejeon (KR); Jaap Andre Haitsma, Eindhoven (NL); Antonius Adrianus Cornelis Maria Kalker, Eindhoven (NL)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Koninklijke Philips Electronics N.V., Eindhoven (NL)

(21) Appl. No.: 10/534,323

(22) PCT Filed: Oct. 31, 2003
(86) PCT No.: PCT/IB03/04894

§ 371 Date: May 9, 2005

(30) Foreign Application Priority Data
Nov. 12, 2002 (EP) 020797205

(51) Int. Cl. H04L 9/00

(52) U.S. Cl. 713/176

(57) ABSTRACT

Disclosed is a method and arrangement for extracting a fingerprint from a multimedia signal, particularly an audio signal, which is invariant to speed changes of the audio signal. To this end, the method comprises extracting (12,13) a set of robust perceptual features from the multimedia signal, for example, the power spectrum of the audio signal. A Fourier-Mellin transform (15) converts the power spectrum into Fourier coefficients that undergo a phase change only if the audio playback speed changes. Their magnitudes or phase differences (16) constitute a speed change-invariant fingerprint. By a thresholding operation (19), the fingerprint can be represented by a compact number of bits.

### FIELD OF THE INVENTION

The invention relates to a method and arrangement for extracting a fingerprint from a multimedia signal.

### BACKGROUND OF THE INVENTION

Fingerprints, in the literature sometimes referred to as hashes or signatures, are binary sequences extracted from multimedia contents, which can be used to identify said contents. Unlike cryptographic hashes of data files (which change as soon as a single bit of the data file changes), fingerprints of multimedia contents (audio, images, video) are to a certain extent invariant to processing such as compression and D/A & A/D conversion. This is generally achieved by extracting the fingerprint from perceptually essential features of the contents.

A prior-art method of extracting a fingerprint from a multimedia signal is disclosed in International Patent Application WO 02/065782. The method comprises the steps of extracting a set of robust perceptual features from the multimedia signal, and converting the set of features into the fingerprint. For audio signals, the perceptual features are energies of the audio contents in selected sub-bands. For image signals, the percetual features are average luminances of blocks into which the image is divided. The conversion into a binary sequence is performed by thresholding, for example, by comparing each feature sample with its neighbors.

An attractive application of fingerprinting is content identification. The artist and title of a music song or video clip can be identified by extracting a fingerprint from an excerpt of the unknown material and sending it to a large database of fingerprints in which said information is stored.

Experiments have shown that the prior-art method of extracting fingerprints from an audio signal is very robust against almost all commonly used audio processing operations, such as MP3 compression and decompression, equalization, re-sampling, noise addition, and D/A & A/D conversion.

It is quite common for radio stations to speed up audio by a few percent. They supposedly do this for two reasons. First, the duration of songs is then shorter and therefore it enables them to broadcast more commercials. Secondly, the beat of the song is faster and the audience seems to prefer this. The speed changes typically lie between zero and four percent.

Speed changes of audio material cause misalignment in both the temporal and the frequency domain. The prior-art fingerprint extraction method does not suffer from misalignment in the temporal domain, because the fingerprint is a concatenation of small sub-fingerprints being extracted from overlapping audio frames. A speed change of; say 2%, merely causes the 250^{th} sub-fingerprint of an excerpt to be extracted at the position of the 255^{th} sub-fingerprint of the corresponding original excerpt.

Misalignment in the frequency domain is caused by spectral energies shifting to other frequencies. The above example of 2% speedup causes all audio frequencies to increase by 2%. In the prior-art audio fingerprint extraction method, this causes the energies in the selected sub-bands (and thus the fingerprint) to be changed. As a result thereof, the fingerprints can no longer be found in a database, unless a plurality of fingerprints corresponding to different speed versions is stored in the database for each song.

Similar considerations apply to image and video material and to other kinds of perceptual features being used for fingerprint extraction.

### OBJECT AND SUMMARY OF THE INVENTION

It is an object of the invention to provide an improved method and arrangement for extracting a fingerprint from multimedia contents. It is a particular object of the invention to provide a method and arrangement for extracting a fingerprint from an audio signal that is substantially invariant to speed changes of the audio signal.

To this end, the method of extracting a fingerprint from a multimedia signal according to the invention comprises the steps of: extracting a set of robust perceptual features from the multimedia signal; subjecting the extracted set of features to a Fourier-Mellin transform; and converting the transformed set of features into a sequence constituting the fingerprint.

The invention exploits the insight that the Fourier-Mellin transform consists of a log mapping and a Fourier transform. The log mapping converts scaling of the energy spectrum due to a speed change in a shift. The subsequent Fourier transform converts the shift into a phase change which is the same for all Fourier coefficients. Magnitudes of the Fourier coefficients are not affected by the speed change. A fingerprint derived from the magnitude or from the derivative of the phase of the Fourier coefficients is thus invariant to speed changes.

### BRIEF DESCRIPTION OF THE DRAWINGS

FIG. 1 shows schematically an arrangement for extracting a fingerprint from a multimedia signal or, equivalently, the corresponding steps of a method of extracting such a fingerprint according to the invention.

FIGS. 2 and 3 show diagrams to illustrate the operation of a log mapping circuit, which is shown in FIG. 1.

### DESCRIPTION OF EMBODIMENTS

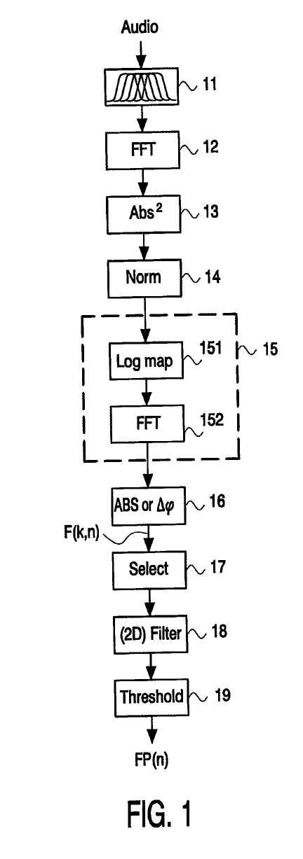

The invention will be described with reference to an arrangement for extracting a fingerprint from an audio signal. FIG. 1 shows schematically such an arrangement according to the invention.

The arrangement comprises a framing circuit 11, which divides the audio signal into overlapping frames of approx. 0.4 seconds and an overlap factor of 31/32. The overlap is to be chosen such that a high correlation between sub-fingerprints of subsequent frames is obtained. Prior to the division into frames, the audio signal has been limited to a frequency range of approx. 300 Hz-3 kHz and down-sampled (not shown), so that each frame comprises 2048 samples.

A Fourier transform circuit 12 computes the spectral representation of every frame. In the next block 13, the power spectrum of the audio frame is computed, for example, by squaring the magnitudes of the (complex) Fourier coefficients. For each frame of 2048 audio signal samples, the power spectrum is represented by 1024 samples (positive and corresponding negative frequencies have the same magnitudes). The samples of the power spectrum constitute a set of robust perceptual features. The spectrum is not substantially affected by operations such as D/A & A/D conversion or MP3 compression.

After calculating the power spectrum, an optional normalization circuit 14 applies local normalization to the power spectrum. Such a normalization (which includes de-convolution and filtering) improves the performance as it obtains a more decisive and robust representation of the power spectrum. Local normalization preserves the important characteristics of the spectrum and is robust against all kinds of audio processing including local modifications of the audio spectrum, such as equalization. The most promising approach is to emphasize the tonal part of the spectrum by normalizing it with its local mean. Mathematically, the normalized spectrum N(ω) is obtained by dividing the spectrum A(ω) by its local mean Lm(ω) as follows:

$$N ( ω ) = \frac{A ( ω )}{Lm ( ω )}$$

The local mean can be calculated in various ways, for example.

$$\begin{matrix}Lm ( ω ) = \frac{1}{2 δ} {\int }_{ω - δ}^{ω + δ} A ( τ ) ⅆ τ ( arithmetic mean ) , or \\ Lm ( ω ) = exp [ \frac{1}{2 δ} {\int }_{ω - δ}^{ω + δ} log A ( τ ) ⅆ τ ] ( geometric mean ) and so on .\end{matrix}$$

The normalized spectrum remains invariant to equalization. Moreover, tonal information is directly related to human hearing and well preserved after most of the audio processing. The importance of tonal information is widely accepted and has been utilized in audio recognition and bit allocation of audio compression. Although local normalization has many advantages, the normalization is not consistent after compression if there are no tonal components between ω−δ and ω+δ. To mitigate this effect, integration over time and a total-energy term is added to IL(ω). Then a modified local mean Lm′(ω) is given as follows:

$${Lm}^{′} ( ω ) = \frac{1}{2 δ} {\int }_{t - Δ}^{t} {\int }_{ω - δ}^{ω + δ} A ( τ ) ⅆ τ + α {\int }_{t - Δ}^{t} {\int }_{- ∞}^{∞} A ( τ ) ⅆ τ$$

where Δ and α are constants, which are determined experimentally. Integration over time makes the normalization more consistent, and the total-energy term limits the increase of small non-tonal components after normalization.

The invention resides in the application of a Fourier-Mellin transform 15 to the power spectrum to achieve speed change resilience. The Fourier-Mellin transform consists of a log mapping process 151 and a Fourier transform (or inverse Fourier transform) 152.

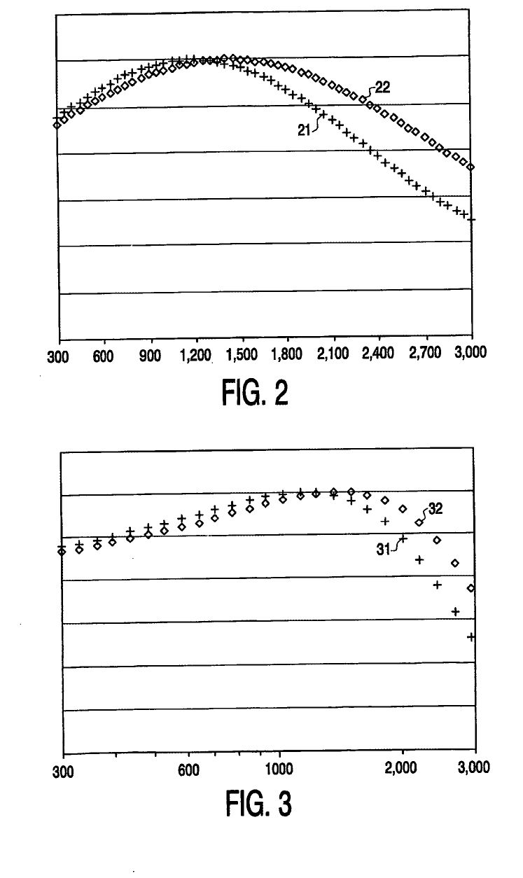

FIGS. 2 and 3 show diagrams to illustrate the log mapping operation. In FIG. 2, reference numeral 21 denotes the samples of the power spectrum of an audio frame as supplied by the Fourier transform 12 in the case that the audio signal is being played back at normal speed. For the sake of convenience, a smooth power spectrum in the range 300-3,000 Hz is shown. In reality, the spectrum will generally exhibit a jagged outline. Reference numeral 22 in FIG. 2 denotes the power spectrum of the same audio frame in the case that the audio signal is being played back at an increased speed. As can be seen in the Figure, the speed change causes the power spectrum to be scaled.

FIG. 3 shows the corresponding power spectra as computed by the log mapping circuit 151. The power spectrum now represents the energy of the audio frame in a selected number of successive logarithmically spaced sub-bands. Reference numeral 31 denotes the log mapped power spectrum for the audio signal being played back at normal speed. Reference numeral 32 denotes the log-mapped power spectrum for the audio signal being played back at the increased speed.

The process of log mapping can be carried out in several ways. In the embodiment, which is shown in FIG. 3, the input power spectrum is interpolated and re-sampled at logarithmically spaced intervals. In another embodiment (not shown), the samples within logarithmically spaced (and sized) sub-bands of the input power spectrum are accumulated to provide respective samples of the log-mapped power spectrum.

The number of samples representing the log-mapped power spectrum is chosen to be such that subsequent operations can be carried out with sufficient precision. In a practical embodiment, the log-mapped power spectrum is represented by 512 samples. It will be appreciated from inspection of FIG. 3 that the log-mapping operation translates the scaling (21→22) of the power spectrum due to the speed change into a shift (31→32). As long as the playback speed of the audio signal does not change within the frame period (which is a reasonable assumption in practice), the shift is the same for all coefficients.

The subsequent Fourier transform 152 translates said shift into a change of the phase of the complex Fourier coefficients. The phase change is the same for all coefficients. Thus, if the speed of the audio signal changes, the phases of all Fourier coefficients computed by Fourier transform circuit 152 change by an identical amount. In other words, the magnitudes of the coefficients as well as their phase differences are invariant to speed changes. They are calculated in a computing circuit 16. As the magnitudes and phase differences are the same for positive and negative frequencies, the number of unique values is 256.

The vector of 256 magnitudes or phase differences representing the log-mapped power spectrum of an audio frame is hereinafter denoted F(k,n), where k=1.256 and n is the audio frame number. In fact, the vector constitutes a speed change-invariant fingerprint. However, the number of values is large, and each value requires a multi-bit representation in a digital fingerprinting system. The number of bits to represent the fingerprint can be reduced by selecting the lowest-order values only. This is performed by a selection circuit 17. It has been found that the 32 lowest values (the most significant coefficients) provide a sufficiently accurate representation of the log-mapped power spectrum.

The number of bits can be further reduced by subjecting the selected magnitudes or phase differences to values to a thresholding process. In a simple embodiment, a thresholding stage 19 generates one bit for each feature sample, for example, a ‘1’ if the value F(k,n) is above a threshold and a ‘0’ if it is below said threshold. Alternatively, a fingerprint bit is given the value ‘1’ if the corresponding feature sample F(k,n) is larger than its neighbor, otherwise it is ‘0’. To this end, the feature samples F(k,n) are first filtered in a one-dimensional temporal filter 18. The present embodiment uses an improved version of the latter alternative. In thus preferred embodiment, a fingerprint bit ‘1’ is generated if the feature sample F(k,n) is larger than its neighbor and if this was also the case in the previous frame, otherwise the fingerprint bit is ‘0’. In this embodiment, the filter 18 is a two-dimensional filter. In mathematical notation:

$$FP ( k , n ) = \{ \begin{matrix}1 & if & F ( k , n ) - F ( k + 1 , n ) - ( F ( k , n - 1 ) - F ( k + 1 , n - 1 ) ) > 0 \\ 0 & if & F ( k , n ) - F ( k + 1 , n ) - ( F ( k , n - 1 ) - F ( k + 1 , n - 1 ) ) \leq 0\end{matrix}$$

When thresholding is used, each sub-fingerprint being extracted from an audio frame has 32 bits.

Although the invention has been described with reference to audio fingerprinting, it can also be applied to other multimedia signals such as images and motion video. While speed changes are often applied to audio signals, affine transformations such as shift, scaling and rotation, are often applied to images and video. The method according to the invention can be used to improve robustness to such affine transformations. In the case of a two-dimensional signal, the log-mapping process 151 is changed into log-polar mapping to make it invariant against rotation as well as scaling (retaining aspect ratio). A log-log mapping makes it invariant to changes of the aspect ratio. The magnitude of the Fourier-Mellin transform (now a 2D transform) and double differentiation of its phase along the frequency axis have the desired affine invariant property.

Disclosed is a method and arrangement for extracting a fingerprint from a multimedia signal, particularly an audio signal, which is invariant to speed changes of the audio signal. To this end, the method comprises extracting (12,13) a set of robust perceptual features from the multimedia signal, for example, the power spectrum of the audio signal. A Fourier-Mellin transform (15) converts the power spectrum into Fourier coefficients that undergo a phase change only if the audio playback speed changes. Their magnitudes or phase differences (16) constitute a speed, change-invariant fingerprint. By a thresholding operation (19), the fingerprint can be represented by a compact number of bits.

1. A method of extracting a fingerprint from a multimedia signal, comprising the steps of:
extracting (12,13) a set of robust perceptual features from the multimedia signal;
subjecting (15) the extracted set of features to a Fourier-Mellin transform;
converting (16,19) the transformed set of features into a sequence constituting the fingerprint.

2. A method as claimed in claim 1, wherein said converting step includes converting (16,ABS) the magnitudes of the Fourier-Mellin transform.

3. A method as claimed in claim 1, wherein said converting step includes converting (16,Δφ) the derivative of the phase of the Fourier-Mellin transform.

4. A method as claimed in claim 1, wherein the multimedia signal is an audio signal and said Fourier-Mellin transform includes a one-dimensional log mapping process being applied to the set of perceptual features.

5. A method as claimed in claim 1, wherein the multimedia signal is an image or video signal and said Fourier-Mellin transform includes a two-dimensional log-polar mapping process being applied to the set of perceptual features.

6. A method as claimed in claim 1, wherein the multimedia signal is an image or video signal and said Fourier-Mellin transform includes a two-dimensional log-log mapping process being applied to the set of perceptual features.

7. A method as claimed in claim 1, wherein said extracting step includes normalization of the set of perceptual features.

8. An apparatus for extracting a fingerprint from a multimedia signal, comprising:
means (12,13) for extracting a set of robust perceptual features from the multimedia signal;
means (15) for subjecting the extracted set of features to a Fourier-Mellin transform;
means (16,19) for converting the transformed set of features into a sequence constituting the fingerprint.
